(19) United States
(12) Patent Application Publication
(10) Pub. No.: US 2007/0064813 A1
(43) Pub. Date: Mar. 22, 2007

(54) Distributed synchronous program superimposition

(75) Inventor: Robert J. Fanfelle, Redwood City, CA (US)

Correspondence Address: Robert E. Krebs;Thelen Reid & Priest LLP, P.O. Box 640640, San Jose, CA, 95164-0640, US

(73) Assignee: Terayon Communication Systems, Inc., a Delaware Corporation

(21) Appl. No.: 11/228,765

(22) Filed: Sep. 16, 2005

(51) Int. Cl. H04B 1/66

(52) U.S. Cl. 375/240.28

(57) ABSTRACT

Distributed synchronous program superimposition may be achieved by a first entity receiving a digital video data stream comprising time-stamped moving picture video data, determining superimposition data for use in superimposing a first one or more digital images on a second one or more digital images in the stream, and sending the stream and the superimposition data for remote superimposing of the first one or more digital images on the second one or more digital images in the stream. A second entity remote from the first entity receives the stream, the superimposition data, and the first one or more digital images, and superimposes the first one or more digital images on the second one or more digital images in the stream to create a superimposed image stream, where the superimposing is based at least in part on the superimposition data.

### BACKGROUND OF THE INVENTION

Digital video content providers such as movie producers or television broadcasters commonly provide digital video content that has been modified relative to the original digital video content. This can be done by superimposing one or more digital images in a video frame of a digital video data stream comprising moving picture video data, at the origin of the digital video data stream. By way of example, a sports telecaster may superimpose or overlay first-down markers on video frames for a football game. The sports telecaster typically broadcasts the moving picture video data modified to include the first-down markers to its local affiliates for subsequent viewing by individual viewers. In this example, changes or modifications to the original moving picture video data are done at the origin of the moving picture video data, and either the original moving picture video data or the modified moving picture video data is distributed to the viewing audience.

As another example, a sports telecaster may have different broadcasts for the same game, depending upon whether the viewing audience is local (“home game”) or non-local (“away game”). The local viewing audience may receive an unmodified broadcast of the game, while non-local audiences may receive a broadcast where one or more images in video frames have been replaced with one or more other images, such as replacing or overlaying the image of the actual billboard containing local advertising, with the image of a billboard containing other advertising. For example, the actual billboard may include an advertisement for a local restaurant, which is what local viewers see. But non-local viewers may see a billboard containing advertising for a nationally-distributed product or service, such as a chain restaurant or a beverage. Thus, for example, a viewer in Los Angeles viewing an LA Lakers basketball game being played in Los Angeles might see a billboard containing advertising local to Los Angeles, while viewers in New York and Chicago viewing the same game might see different advertising on the same billboard. Still, viewers in New York and Chicago would see the same non-local advertising. Again, in this example, changes or modifications to the original moving picture video data are done at the origin of the moving picture video data, and either the original moving picture video data or the modified moving picture video data is distributed to the viewing audience.

FIG. 1 is a block diagram that illustrates superimposing a digital image on a digital video data stream comprising moving picture video data, at the source of the digital image. As shown in FIG. 1, camera 125 is adapted to send a scene image stream 115 comprising moving picture video data for a scene 105 to one or more image processors 120 co-located with the camera 125 and the scene 105, all at the source of the moving picture video data 100. Image processor 120 is adapted to receive the scene image stream. Image processor may also receive sensor information 110 from one or more sensors at the scene 105. The sensor information 110 may indicate, by way of example, the coordinates of digital images (i.e. billboards) in scene 105 that may be overlayed with one or more other digital images. Image processor 120 is further adapted to determine a digital image in scene image stream 115 that may be overlayed, and to overlay the digital image with superimposable image 130 to create a superimposed image stream 145. Superimposed image stream 145 is received and displayed by a display device 135 of user 140.

Additionally, digital video recording devices, such as those manufactured by TiVo Inc., of Alviso, Calif., may be used to “fast forward” through or skip commercial advertisements in previously recorded digital video content, such as digital video broadcasts and DVDs. This process, also known as “time-shifting”, results in decreased viewing of the commercial advertisements, and thus decreased advertising revenues for digital video content providers.

Accordingly, a need exists in the art for an improved solution that provides locally-pertinent content to be provided to particular demographics or regions. A further need exists for such a solution that lessens the effect of time-shifting to avoid advertisements.

### SUMMARY OF THE INVENTION

Distributed synchronous program superimposition may be achieved by a first entity receiving a digital video data stream comprising time-stamped moving picture video data, determining superimposition data for use in superimposing a first one or more digital images on a second one or more digital images in the stream, and sending the stream and the superimposition data for remote superimposing of the first one or more digital images on the second one or more digital images in the stream. A second entity remote from the first entity receives the stream, the superimposition data, and the first one or more digital images, and superimposes the first one or more digital images on the second one or more digital images in the stream to create a superimposed image stream, where the superimposing is based at least in part on the. superimposition data.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram that illustrates superimposing a digital image on a digital video data stream comprising moving picture video data, at the source of the digital image.

FIG. 2 is a block diagram of a computer system suitable for implementing aspects of the present invention.

FIG. 3 is a block diagram that illustrates a system for distributed synchronous program superimposition in accordance with one embodiment of the present invention.

FIG. 4A is an illustration of one frame of a digital video data stream comprising moving picture video data, showing the result of superimposing an image on another image in the frame.

FIG. 4B is an illustration of one frame of a digital video data stream comprising moving picture video data, showing the result of superimposing an image on another image in the frame.

FIG. 4C is an illustration of one frame of a digital video data stream comprising moving picture video data, showing the result of superimposing an image on another image in the frame.

FIG. 4D is an illustration of one frame of a digital video data stream comprising moving picture video data, showing the result of superimposing an image on another image in the frame.

FIG. 5A is a flow diagram that illustrates a method for image processing in the system for distributed synchronous program superimposition of FIG. 3, in accordance with one embodiment of the present invention.

FIG. 5B is a flow diagram that illustrates a method for superimposing one or more digital images in the system for distributed synchronous program superimposition of FIG. 3, in accordance with one embodiment of the present invention.

FIG. 6 is a block diagram that illustrates a system for distributed synchronous program superimposition in accordance with one embodiment of the present invention.

FIG. 7A is a flow diagram that illustrates a method for image processing in the system for distributed synchronous program superimposition of FIG. 6, in accordance with one embodiment of the present invention.

FIG. 7B is a flow diagram that illustrates a method for superimposing one or more digital images in the system for distributed synchronous program superimposition of FIG. 6, in accordance with one embodiment of the present invention.

FIG. 8 is a block diagram that illustrates a system for distributed synchronous program superimposition in accordance with one embodiment of the present invention.

FIG. 9A is a flow diagram that illustrates a method for image processing in the system for distributed synchronous program superimposition of FIG. 8, in accordance with one embodiment of the present invention.

FIG. 9B is a flow diagram that illustrates a method for superimposing one or more digital images in the system for distributed synchronous program superimposition of FIG. 8, in accordance with one embodiment of the present invention.

FIG. 10 is a block diagram that illustrates a system for multi-level distributed synchronous program superimposition in accordance with one embodiment of the present invention.

FIG. 11A is a flow diagram that illustrates a method for image processing in the system for multi-level distributed synchronous program superimposition of FIG. 10, in accordance with one embodiment of the present invention.

FIG. 11B is a flow diagram that illustrates a first method for superimposing one or more digital images in the system for multi-level distributed synchronous program superimposition of FIG. 10, in accordance with one embodiment of the present invention.

FIG. 11C is a flow diagram that illustrates a second method for superimposing one or more digital images in the system for multi-level distributed synchronous program superimposition of FIG. 10, in accordance with one embodiment of the present invention.

FIG. 12A is a block diagram that illustrates a system for distributed synchronous program superimposition, comprising a display device comprising one or more superimposers, in accordance with one embodiment of the present invention.

FIG. 12B is a block diagram that illustrates a system for distributed synchronous program superimposition, comprising a set top box comprising one or more superimposers, in accordance with one embodiment of the present invention.

FIG. 12C is a block diagram that illustrates a system for distributed synchronous program superimposition, comprising a local ISP comprising one or more superimposers, in accordance with one embodiment of the present invention.

FIG. 12D is a block diagram that illustrates a system for distributed synchronous program superimposition, comprising a regional ISP comprising one or more superimposers, in accordance with one embodiment of the present invention.

FIG. 13A is a block diagram that illustrates a digital video data stream for use in a system for distributed synchronous program superimposition in accordance with one embodiment of the present invention.

FIG. 13B is a block diagram that illustrates digital video data streams for use in a system for distributed synchronous program superimposition in accordance with one embodiment of the present invention.

FIG. 13C. is a block diagram that illustrates digital video data streams for use in a system for distributed synchronous program superimposition in accordance with one embodiment of the present invention.

FIG. 13D is a block diagram that illustrates digital video data streams for use in a system for distributed synchronous program superimposition in accordance with one embodiment of the present invention.

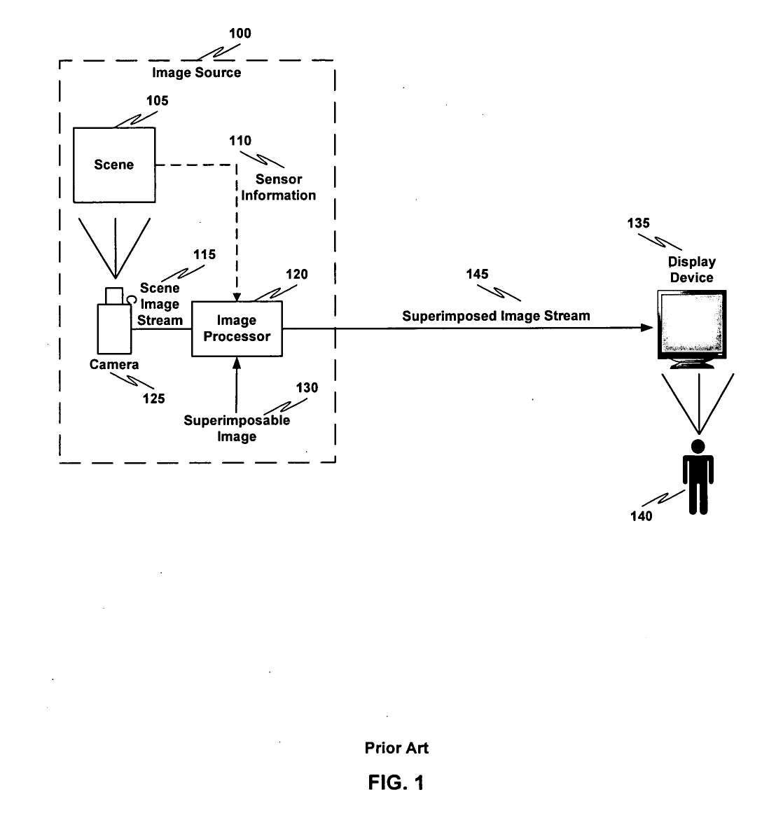

### DETAILED DESCRIPTION

Embodiments of the present invention are described herein in the context of a system and method for distributed synchronous program superimposition. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), comprising field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft® Windows® XP and Windows® 2000, available from Microsoft Corporation of Redmond, Wash., or various versions of the Unix operating system such as Linux available from a number of vendors. The method may also be implemented on a mobile device running an OS such as Windows® CE, available from Microsoft Corporation of Redmond, Wash., Symbian OS™, available from Symbian Ltd of London, UK, Palm OS®, available from PalmSource, Inc. of Sunnyvale, Calif., and various embedded Linux operating systems. Embedded Linux operating systems are available from vendors including MontaVista Software, Inc. of Sunnyvale, Calif., and FSMLabs, Inc. of Socorro, N. Mex. The method may also be implemented on a multiple-processor system, or in a computing environment comprising various peripherals such as input devices, output devices, displays, pointing devices, memories, storage devices, media interfaces for transferring data to and from the processor(s), and the like. In addition, such a computer system or computing environment may be networked locally, or over the Internet.

In the context of the present invention, the term “network” comprises local area networks, wide area networks, the Internet, cable television systems, telephone systems, wireless telecommunications systems, fiber optic networks, ATM networks, frame relay networks, satellite communications systems, and the like. Such networks are well known in the art and consequently are not further described here.

In the context of the present invention, the term “identifier” describes one or more numbers, characters, symbols, or the like. More generally, an “identifier” describes any entity that can be represented by one or more bits.

In the context of the present invention, the term “digital image” describes an image represented by one or more bits, regardless of whether the image was originally represented as an analog image.

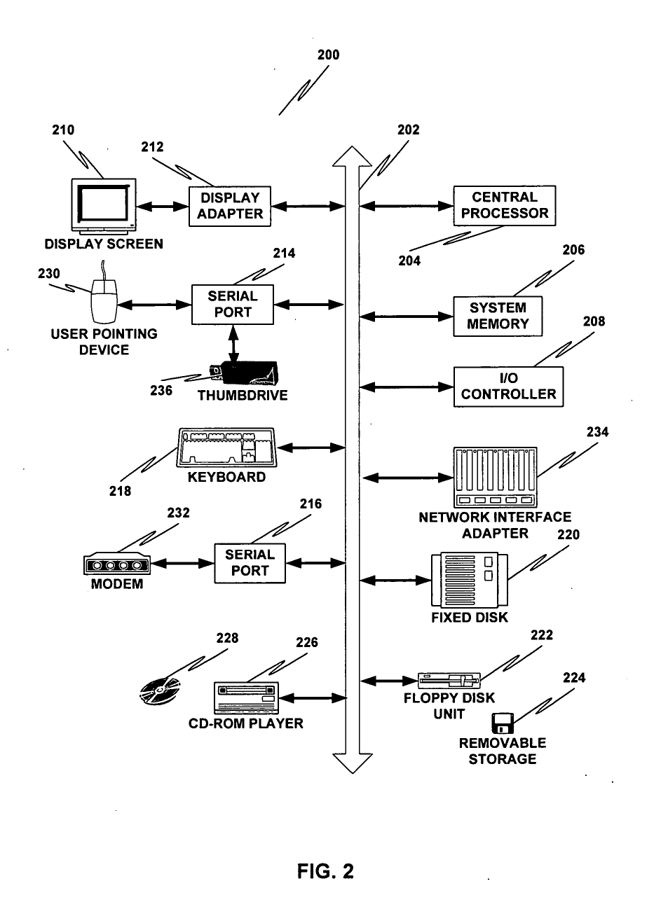

FIG. 2 depicts a block diagram of a computer system 200 suitable for implementing aspects of the present invention. As shown in FIG. 2, computer system 200 comprises a bus 202 which interconnects major subsystems such as a central processor 204, a system memory 206 (typically RAM), an input/output (I/O) controller 208, an external device such as a display screen 210 via display adapter 212, serial ports 214 and 216, a keyboard 218, a fixed disk drive 220, a floppy disk drive 222 operative to receive a floppy disk 224, and a CD-ROM player 226 operative to receive a CD-ROM 228. Many other devices can be connected, such as a pointing device 230 (e.g., a mouse) connected via serial port 214 and a modem 232 connected via serial port 216. Modem 232 may provide a direct connection to a remote server via a telephone link or to the Internet via a POP (point of presence). Alternatively, a network interface adapter 234 may be used to interface to a local or wide area network using any wired or wireless network interface system known to those skilled in the art (e.g., Ethernet, xDSL, AppleTalk™, IEEE 802.11, and Bluetooth®).

Many other devices or subsystems (not shown) may be connected in a similar manner. Also, it is not necessary for all of the devices shown in FIG. 2 to be present to practice the present invention, as discussed below. Furthermore, the devices and subsystems may be interconnected in different ways from that shown in FIG. 2. The operation of a computer system such as that shown in FIG. 2 is readily known in the art and is not discussed in detail in this application, so as not to overcomplicate the present discussion. Code to implement the present invention may be operably disposed in system memory 206 or stored on storage media such as fixed disk 220, floppy disk 224, CD-ROM 228, or thumbdrive 236.

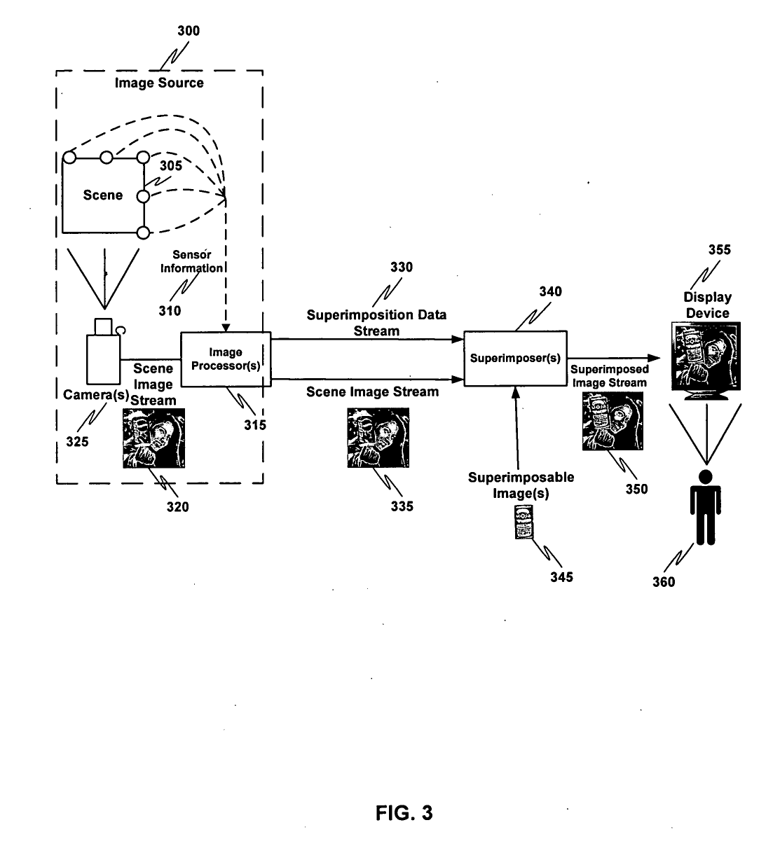

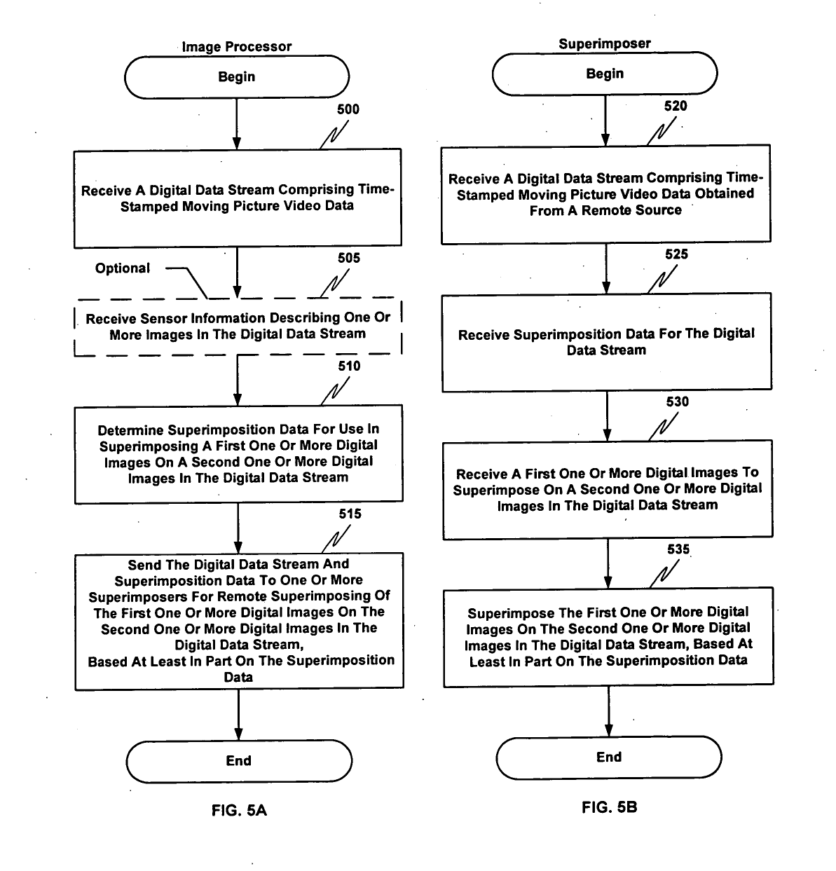

FIGS. 3, 5A, and 5B illustrate a system and method for distributed synchronous program superimposition in accordance with one embodiment of the present invention.

Turning now to FIG. 3, a block diagram that illustrates a system for distributed synchronous program superimposition in accordance with one embodiment of the present invention is presented. As shown in FIG. 3, one or more imaging devices such as cameras 325 or the like are adapted to send a scene image stream 320 comprising a digital video data stream having time-stamped moving picture video data for a scene 305 to one or more image processors 315. The one or more image processors 315 comprise one or more memories and at least one processor adapted to receive the scene image stream 320. The one or more image processors 315 optionally receive sensor information 310 from one or more sensors at the scene 305. The sensor information 310 may indicate, by way of example, the coordinates of digital images (e.g. billboards) in scene 305 that may be superimposed on one or more other digital images.

The one or more image processors 315 are further adapted to determine superimposition data 330 for use in superimposing a first one or more digital images on a second one or more digital images in the digital video data stream 320, and to send both the scene image stream 335 and the superimposition data 330 to one or more superimposers 340 for remote superimposing of the first one or more digital images 345 on the second one or more digital images in the digital video data stream, based at least in part on the superimposition data 330.

According to one embodiment of the present invention, the first one or more digital images 345 are received from a remote location. According to another embodiment of the present invention, the first one or more digital images 345 are created or stored locally.

The superimposition data 330 comprises information regarding the second one or more digital images such as, by way of example, the orientation, lighting, shading, opacity, aspect ratio, and origination of the second one or more digital images. The superimposition data 330 may comprise information received from the one or more sensors at the scene 305, information derived from the one or more sensors at the scene 305, or both.

The orientation information may be used, for example, to put the first one or more digital images in a similar orientation as the second one or more digital images before the first one or more digital images are superimposed. Thus, for example, if the image being superimposed is a straight-on view of a beverage can, and if the corresponding second one or more digital images are offset, the image of the beverage can is processed to be in a similar offset orientation before being superimposed. Any 3-D model known in the art may be used as part of the superimposition. By way of example, the superimposition may utilize one or more 3D wireframe models, one or more 3D surface models, one or more 3D solid models, or a combination thereof. Additionally, information from sensed from the one or more sensors at the scene 305 may be sensed in 2D, 3D, or both.

Likewise, the lighting information may be used, for example, to apply similar lighting characteristics to the first one or more digital images as the lighting characteristics of the second one or more digital images before the first one or more digital images are superimposed. Likewise, the shading information may be used, for example, to apply similar shading characteristics to the first one or more digital images as the shading characteristics of the second one or more digital images before the first one or more digital images are superimposed. Likewise, the opacity information may be used, for example, to apply similar opacity characteristics to the first one or more digital images as the opacity characteristics of the second one or more digital images before the first one or more digital images are superimposed. Likewise, the aspect ratio information may be used, for example, to apply a similar aspect ratio to the first one or more digital images as the aspect ratio of the second one or more digital images before the first one or more digital images are superimposed. Likewise, the origination information may be used, for example, to apply similar origination characteristics to the first one or more digital images as the origination characteristics of the second one or more digital images before the first one or more digital images are superimposed.

According to one embodiment of the present invention, superimposition of the first one or more digital images comprises complete replacement of the second one or more digital images. According to another embodiment of the present invention, superimposition of the first one or more digital images comprises partial replacement or blending of the second one or more digital images. The partial replacement or blending may be based at least in part on the opacity of the first one or more images, the opacity of the second one or more digital images, or both.

According to one embodiment of the present invention, the first one or more digital images comprise one or more static images. According to another embodiment of the present invention, the first one or more images comprise time-stamped moving picture video data.

The one or more superimposers 340 are operatively coupled to the one or more image processors 315, e.g. via a network, dedicated, or other communications means. The one or more superimposers comprise one or more memories and at least one processor adapted to receive the scene image stream 335 comprising time-stamped moving picture video data obtained from a remote source, receive superimposition data 330 for the digital video data stream, receive a first one or more digital images 345 to superimpose on a second one or more digital images, and superimpose the first one or more digital images 345 on the second one or more digital images in the digital video data stream 335, based at least in part on the superimposition data 330. Synchronization between the scene image stream 335, the superimposition data 330, and the one or more superimposable images 345 may be based at least in part on time stamp information in the scene image stream 335 and the superimposition data 330.

Superimposed image stream 350 is received and displayed by a display device 355 of user 360. As shown in FIG. 3, scene image stream 320 depicts a woman presenting a Pepsi can, which is tilted slightly to the left. The one or more image processors 315 determine superimposition data for the Pepsi can, comprising an indication of the can's tilted orientation and aspect ratio. The one or more superimposers 340 apply a similar aspect ratio and orientation to the one or more superimposable images 345, which is an image of a Budweiser can, and superimpose the resulting image on the scene image stream 335, resulting in a superimposed image stream 350 depicting the same woman presenting a Budweiser can.

According to one embodiment of the present invention, the one or more image processors 315 are co-located with the one or more cameras 325 and scene 305. According to another embodiment of the present invention, at least part of the one or more image processors 315 are not co-located with the one or more cameras 325, scene 305, or both.

According to one embodiment of the present invention, superimposition data 330 and scene image stream 335 comprise separate data streams having time-stamped data. The two data streams may be communicated using the same communication medium; alternatively the two data streams may be communicated using different communication mediums. The two data streams may also be communicated using the same communication protocol; alternatively the two data streams may be communicated using different communication protocols. The two data streams may also be communicated at different times.

According to another embodiment of the present invention, superimposition data 330 and scene image stream 335 comprise a single multiplexed data stream.

According to one embodiment of the present invention, at least part of the data communicated between the one or more image processors 315 and the one or more superimposers 340 are communicated in a “user data” data field specified by an MPEG (Motion Pictures Experts Group) standard. Exemplary MPEG standards include, by way of example, MPEG-1, MPEG-2, and MPEG-4. According to another embodiment of the present invention, at least part of the data communicated between the one or more image processors 315 and the one or more superimposers 340 are communicated using one or more picture header extension codes specified by an MPEG standard. According to another embodiment of the present invention, at least part of the data communicated between the one or more image processors 315 and the one or more superimposers 340 are communicated using a separate data PES (Packetized Elementary Stream) specified by an MPEG standard.

According to one embodiment of the present invention, the rate at which the one or more superimposers 340 update frames within the scene image stream 335 is based at least in part on the update rate of the original content at the image source 300. According to another embodiment of the present invention, the rate at which the one or more superimposers 340 update frames within the scene image stream 335 is based at least in part on the refresh rate of the display device 355.

According to one embodiment of the present invention, the one or more superimposable images 345 are provided by a global server (not shown in FIG. 3) having a store of one or more superimposable images. The determination of which superimposable image to use may be based in part on, by way of example, the geographic area or service area of viewers served by the one or more superimposers 340. According to another embodiment of the present invention, the one or more superimposable images 345 are provided by one or more regional servers (not shown in FIG. 3) having a store of one or more superimposable images. Each of the one or more regional servers may correspond to a particular geographic region or service area. The determination of which superimposable image to use may be based in part on, by way of example, the geographic area or service area of viewers served by the one or more superimposers 340.

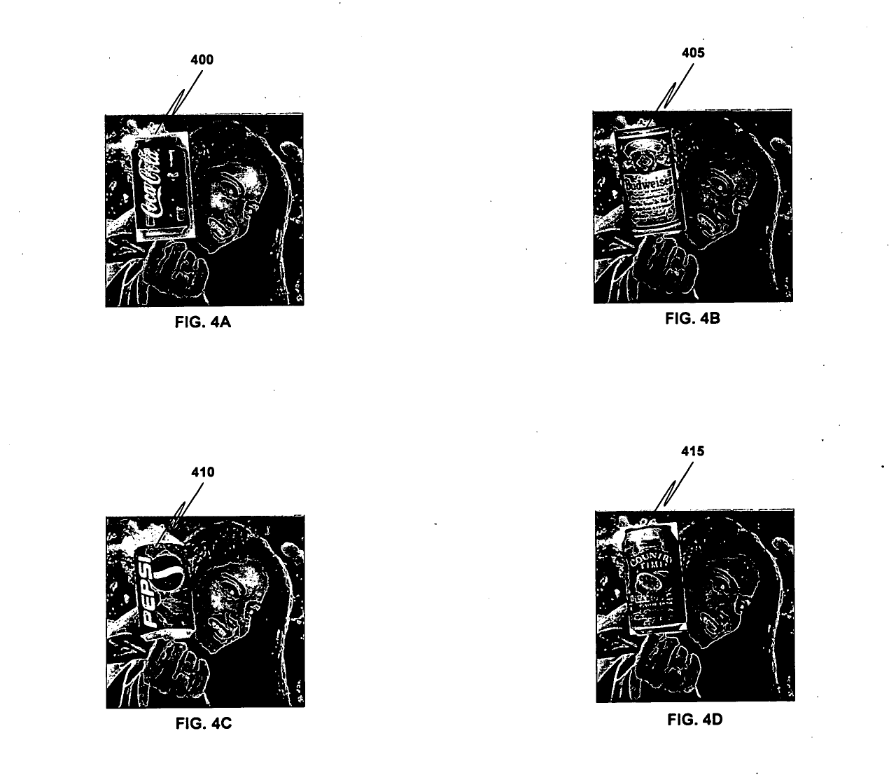

FIGS. 4A-4D illustrate one frame of a digital video data stream comprising moving picture video data, showing the result of superimposing an image on another image in the frame. FIGS. 4A-4D are used herein to illustrate embodiments of the present invention. The background image of FIGS. 4A-4D are identical—a woman looking at the camera and presenting an item resting on the woman's index finger. The item presented in FIG. 4A is a Coca-Cola can 400, the item presented in FIG. 4B is a Budweiser can 405, the item presented in FIG. 4C is a Pepsi can 410, and the item presented in FIG. 4D is a Country Time Lemonade can 415. Note the items presented in FIGS. 4A-4D have similar aspect ratios, shading, opacity, and orientation properties.

Turning now to FIG. 5A, a flow diagram that illustrates a method for image processing in the system for distributed synchronous program superimposition FIG. 3, in accordance with one embodiment of the present invention is presented. FIG. 5A describes a process performed by the one or more image processors 315 of FIG. 3. The processes illustrated in FIG. 5A may be implemented in hardware, software, firmware, or a combination thereof. At 500, a digital video data stream comprising time-stamped moving picture video data is received. At 505, sensor information describing one or more images in the digital video data stream is optionally received. At 510, superimposition data for use in superimposing a first one or more digital images on a second one or more digital images in the digital video data stream are determined. At 515, the digital video data stream and superimposition data are sent to one or more superimposers for remote superimposing of the first one or more digital images on the second one or more digital images in the digital video data stream, based at least in part on the superimposition data.

Turning now to FIG. 5B, a flow diagram that illustrates a method for superimposing one or more digital images in the system for distributed synchronous program superimposition of FIG. 3, in accordance with one embodiment of the present invention is presented. FIG. 5B describes a process performed by the one or more superimposers 340 of FIG. 3. The processes illustrated in FIG. 5B may be implemented in hardware, software, firmware, or a combination thereof. At 520, a digital video data stream comprising time-stamped moving picture video data obtained from a remote source is received. At 525, superimposition data for the digital video data stream is received. At 530, a first one or more digital images to superimpose on a second one or more digital images in the digital video data stream are received. At 535, the first one or more digital images are superimposed on the second one or more digital images in the digital video data stream, based at least in part on the superimposition data.

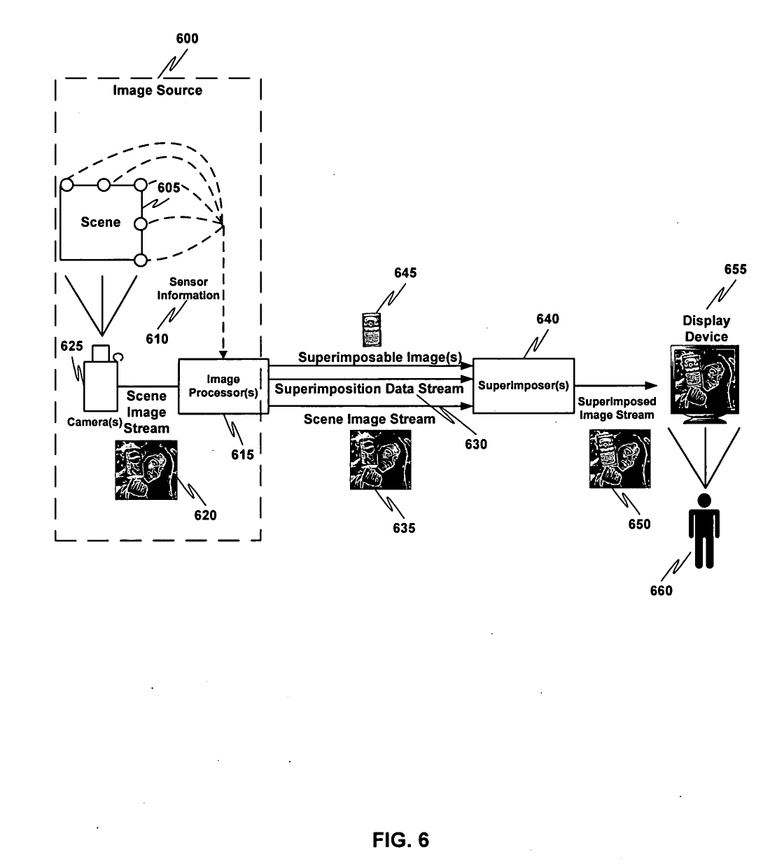

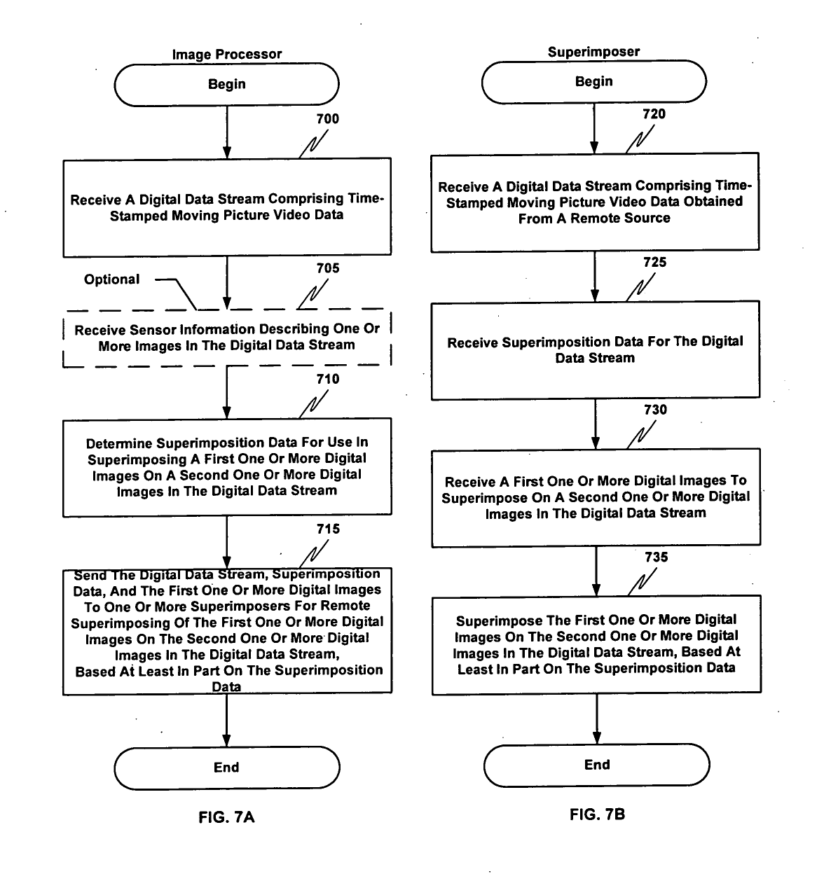

FIGS. 6-7B illustrate a system and method for distributed synchronous program superimposition in accordance with one embodiment of the present invention. Unlike the embodiment illustrated by FIGS. 3, 5A, and 5B, the embodiment illustrated in FIGS. 6-7B describes one or more superimposable images being supplied from one or more image processors to one or more superimposers.

Turning now to FIG. 6, a block diagram that illustrates a system for distributed synchronous program superimposition in accordance with one embodiment of the present invention is presented. FIG. 6 is similar to FIG. 3, except FIG. 6 shows one or more superimposable images 645 being supplied from one or more image processors 615 to one or more superimposers 640. As shown in FIG. 6, one or more imaging devices such as cameras 625 or the like are adapted to send a scene image stream 620 comprising a digital video data stream having time-stamped moving picture video data for a scene 605 to one or more image processors 615. The one or more image processors 615 comprise one or more memories and at least one processor adapted to receive the scene image stream 620. The one or more image processors 615 optionally receive sensor information 610 from one or more sensors at the scene 605. The sensor information 610 may indicate, by way of example, the coordinates of digital images (e.g. billboards) in scene 605 that may be superimposed on one or more other digital images.

The one or more image processors 615 are further adapted to determine superimposition data 630 for use in superimposing a first one or more digital images 645 on a second one or more digital images in the digital video data stream 620, and to send the scene image stream 635, the superimposition data 630, and the first one or more digital images 645 to one or more superimposers 640 for remote superimposing of the first one or more digital images 645 on the second one or more digital images in the digital video data stream, based at least in part on the superimposition data 630.

The one or more superimposers 640 are operatively coupled to the one or more image processors 615, e.g. via a network, dedicated, or other communications means. The one or more superimposers 640 comprise one or more memories and at least one processor adapted to receive the scene image stream 635 comprising time-stamped moving picture video data obtained from a remote source, receive superimposition data 630 for the digital video data stream, receive a first one or more digital images 645 to superimpose on a second one or more digital images, and superimpose the first one or more digital images 645 on the second one or more digital images in the digital video data stream 635, based at least in part on the superimposition data 630. Synchronization between the scene image stream 635, the superimposition data 630, and the one or more superimposable images 645 may be based at least in part on time stamp information in the scene image stream 635 and the superimposition data 630. Superimposed image stream 650 is received and displayed by a display device 655 of user 660.

According to one embodiment of the present invention, the one or more image processors 615 are co-located with the one or more cameras 625 and scene 605. According to another embodiment of the present invention, at least part of the one or more image processors 615 are not co-located with the one or more cameras 625, scene 605, or both.

According to one embodiment of the present invention, superimposition data 630, scene image stream 635, and the one or more superimposable images 645 comprise separate data streams having time-stamped data. The three data streams may be communicated using the same communication medium; alternatively the three data streams may be communicated using different communication mediums. The three data streams may also be communicated using the same communication protocol; alternatively the three data streams may be communicated using different communication protocols. The three data streams may also be communicated at different times.

According to another embodiment of the present invention, superimposition data 630, scene image stream 635, and the one or more superimposable images 645 comprise a single multiplexed data stream.

According to another embodiment of the present invention, two of the superimposition data 630, scene image stream 635, and the one or more superimposable images 645 comprise a single multiplexed data stream, and the third comprises a second data stream.

According to one embodiment of the present invention, at least part of the data communicated between the one or more image processors 615 and the one or more superimposers 640 are communicated in a “user data” data field specified by an MPEG standard. Exemplary MPEG standards include, by way of example, MPEG-1, MPEG-2, and MPEG-4. According to another embodiment of the present invention, at least part of the data communicated between the one or more image processors 615 and the one or more superimposers 640 are communicated using one or more picture header extension codes specified by an MPEG standard. According to another embodiment of the present invention, at least part of the data communicated between the one or more image processors 615 and the one or more superimposers 640 are communicated using a separate data PES (Packetized Elementary Stream) specified by an MPEG standard.

According to one embodiment of the present invention, the rate at which the one or more superimposers 640 update frames within the scene image stream 635 is based at least in part on the update rate of the original content at the image source 600. According to another embodiment of the present invention, the rate at which the one or more superimposers 640 update frames within the scene image stream 635 is based at least in part on the refresh rate of the display device 655.

According to one embodiment of the present invention, the one or more superimposable images 645 are provided by a global server (not shown in FIG. 6) having a store of one or more superimposable images. The determination of which superimposable image to use may be based in part on, by way of example, the geographic area or service area of viewers served by the one or more superimposers 640. According to another embodiment of the present invention, the one or more superimposable images 645 are provided by one or more regional servers (not shown in FIG. 6) having a store of one or more superimposable images. Each of the one or more regional servers may correspond to a particular geographic region or service area. The determination of which superimposable image to use may be based in part on, by way of example, the geographic area or service area of viewers served by the one or more superimposers 640.

Turning now to FIG. 7A, a flow diagram that illustrates a method for image processing in the system for distributed synchronous program superimposition of FIG. 6, in accordance with one embodiment of the present invention is presented. FIG. 7A describes a process performed by the one or more image processors 615 of FIG. 6. The processes illustrated in FIG. 7A may be implemented in hardware, software, firmware, or a combination thereof. The process described for FIG. 7A is similar to FIG. 5A, except that at 715, the first one or more digital images to superimpose 645 are sent in addition to the digital video data stream 635 and the superimposition data 630. At 700, a digital video data stream comprising time-stamped moving picture video data is received. At 705, sensor information describing one or more images in the digital video data stream is optionally received. At 710, superimposition data for use in superimposing a first one or more digital images on a second one or more digital images in the digital video data stream are determined. At 715, the digital video data stream, superimposition data, and the first one or more digital images to superimpose are sent to one or more superimposers for remote superimposing of the first one or more digital images on the second one or more digital images in the digital video data stream, based at least in part on the superimposition data.

Turning now to FIG. 7B, a flow diagram that illustrates a method for superimposing one or more digital images in the system for distributed synchronous program superimposition of FIG. 6, in accordance with one embodiment of the present invention is presented. FIG. 7B describes a process performed by the one or more superimposers 640 of FIG. 6. The processes illustrated in FIG. 7B may be implemented in hardware, software, firmware, or a combination thereof. The process described for 7B is similar to FIG. 5B, except at 730, the first one or more digital images to superimpose are received from the image processor 615. At 720, a digital video data stream comprising time-stamped moving picture video data obtained from a remote source is received. At 725, superimposition data for the digital video data stream is received. At 730, a first one or more digital images to superimpose on a second one or more digital images in the digital video data stream are received. At 735, the first one or more digital images are superimposed on the second one or more digital images in the digital video data stream, based at least in part on the superimposition data.

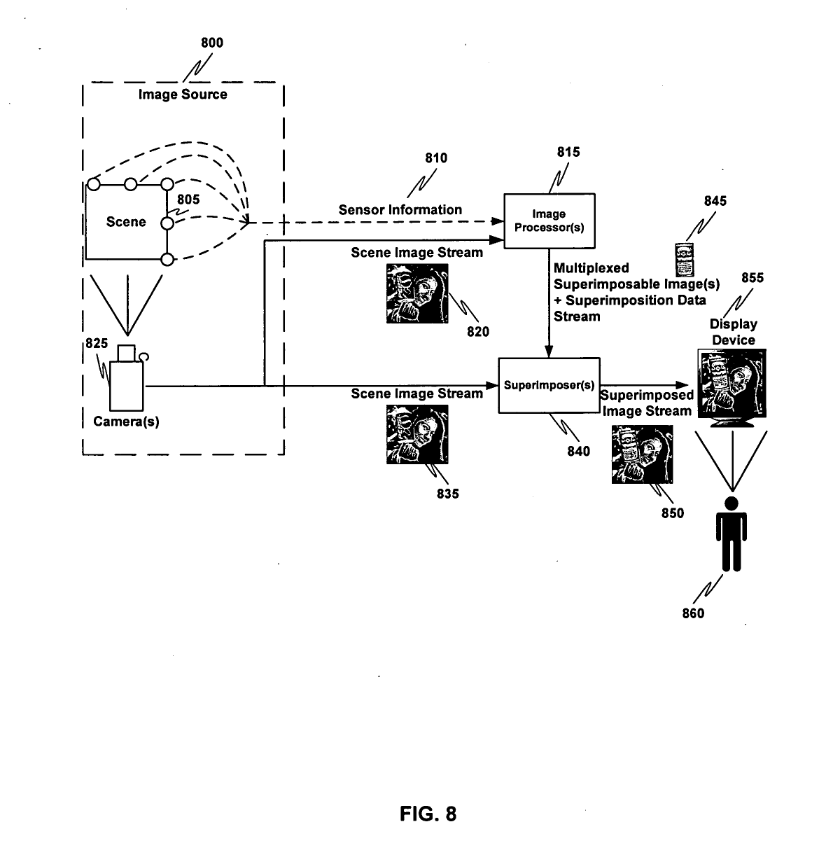

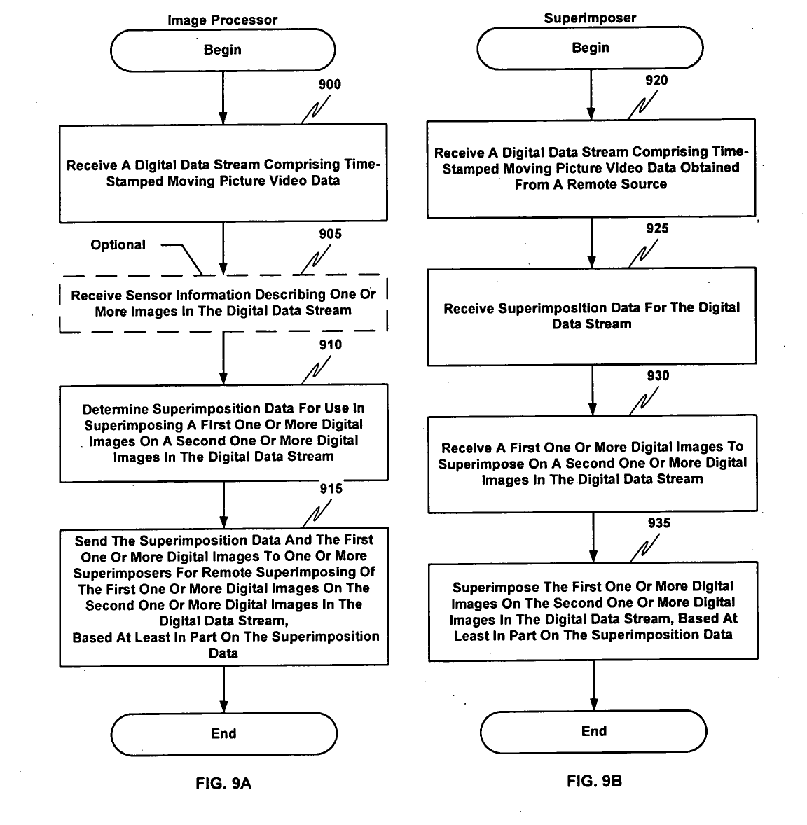

FIGS. 8-9B illustrate a system and method for distributed synchronous program superimposition in accordance with one embodiment of the present invention. FIGS. 8-9B describe image processing remote from the image source.

Turning now to FIG. 8, a block diagram that illustrates a system for distributed synchronous program superimposition in accordance with one embodiment of the present invention is presented. As shown in FIG. 8, one or more imaging devices such as cameras 825 or the like are adapted to send a scene image stream 820 comprising a digital video data stream having time-stamped moving picture video data for a scene 805 to one or more image processors 815. The one or more image processors 815 comprise one or more memories and at least one processor adapted to receive the scene image stream 820. The one or more image processors 815 optionally receive sensor information 810 from one or more sensors at the scene 805.

The one or more image processors 815 are further adapted to determine superimposition data for use in superimposing a first one or more digital images on a second one or more digital images in the digital video data stream, and to send both the superimposition data and one or more digital images superimpose to one or more superimposers for remote superimposing of the first one or more digital images on a second one or more digital images in the scene image stream, based at least in part on the superimposition data.

The one or more superimposers 840 are operatively coupled to the one or more image processors 815, e.g. via a network, dedicated, or other communications means. The one or more superimposers 840 comprise one or more memories and at least one processor adapted to receive the scene image stream 835 comprising time-stamped moving picture video data obtained from a remote source, receive superimposition data for the digital video data stream, receive a first one or more digital images to superimpose on a second one or more digital images, and superimpose the first one or more digital images on the second one or more digital images in the digital video data stream, based at least in part on the superimposition data. Synchronization between the streams may be based at least in part on time stamp information in the streams. Superimposed image stream 850 is received and displayed by a display device 855 of user 860.

According to one embodiment of the present invention, the one or more superimposable images and the superimposition data are communicated between the one or more image processors 815 and the one or more superimposers 840 in separate data streams having time-stamped data. The two data streams may be communicated using the same communication medium; alternatively the two data streams may be communicated using different communication mediums. The two data streams may also be communicated using the same communication protocol; alternatively the two data streams may be communicated using different communication protocols. The two data streams may also be communicated at different times.

According to another embodiment of the present invention, the one or more superimposable images and the superimposition data are multiplexed into a single data stream for communication between the one or more image processors 815 and the one or more superimposers 840.

According to one embodiment of the present invention, at least part of the data communicated between the one or more image processors 815 and the one or more superimposers 840 are communicated in a “user data” data field specified by an MPEG standard. Exemplary MPEG standards include, by way of example, MPEG-1, MPEG-2, and MPEG-4. According to another embodiment of the present invention, at least part of the data communicated between the one or more image processors 815 and the one or more superimposers 840 are communicated using one or more picture header extension codes specified by an MPEG standard. According to another embodiment of the present invention, at least part of the data communicated between the one or more image processors 815 and the one or more superimposers 840 are communicated using a separate data PES (Packetized Elementary Stream) specified by an MPEG standard.

According to one embodiment of the present invention, the rate at which the one or more superimposers 840 update frames within the scene image stream 835 is based at least in part on the update rate of the original content at the image source 800. According to another embodiment of the present invention, the rate at which the one or more superimposers 840 update frames within the scene image stream 835 is based at least in part on the refresh rate of the display device 855.

According to one embodiment of the present invention, the one or more superimposable images are provided by a global server (not shown in FIG. 8) having a store of one or more superimposable images. The determination of which superimposable image to use may be based in part on, by way of example, the geographic area or service area of viewers served by the one or more superimposers 840. According to another embodiment of the present invention, the one or more superimposable images are provided by one or more regional servers (not shown in FIG. 8) having a store of one or more superimposable images. Each of the one or more regional servers may correspond to a particular geographic region or service area. The determination of which superimposable image to use may be based in part on, by way of example, the geographic area or service area of viewers served by the one or more superimposers 840.

Turning now to FIG. 9A, a flow diagram that illustrates a method for image processing in the system for distributed synchronous program superimposition of FIG. 8, in accordance with one embodiment of the present invention is presented. FIG. 9A describes a process performed by the one or more image processors 815 of FIG. 8. The processes illustrated in FIG. 9A may be implemented in hardware, software, firmware, or a combination thereof. At 900, a digital video data stream comprising time-stamped moving picture video data is received. At 905, sensor information describing one or more images in the digital video data stream is optionally received. At 910, superimposition data for use in superimposing a first one or more digital images on a second one or more digital images in the digital video data stream are determined. At 915, the first one or more digital images and the superimposition data are sent to one or more superimposers for remote superimposing of the first one or more digital images on the second one or more digital images in the digital video data stream, based at least in part on the superimposition data.

Turning now to FIG. 9B, a flow diagram that illustrates a method for superimposing one or more digital images in the system for distributed synchronous program superimposition of FIG. 8, in accordance with one embodiment of the present invention is presented. FIG. 9B describes a process performed by the one or more superimposers 840 of FIG. 8. The processes illustrated in FIG. 9B may be implemented in hardware, software, firmware, or a combination thereof. At 920, a digital video data stream comprising time-stamped moving picture video data obtained from a remote source is received. At 925, superimposition data for the digital video data stream is received. At 930, a first one or more digital images to superimpose on a second one or more digital images in the digital video data stream are received. At 935, the first one or more digital images are superimposed on the second one or more digital images in the digital video data stream, based at least in part on the superimposition data.

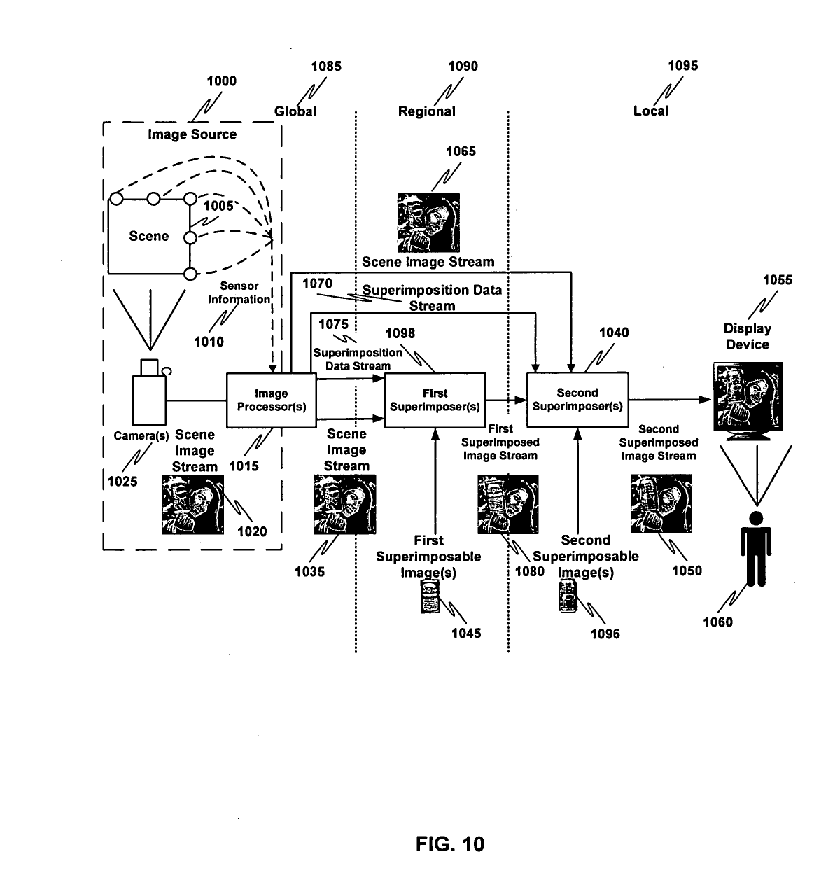

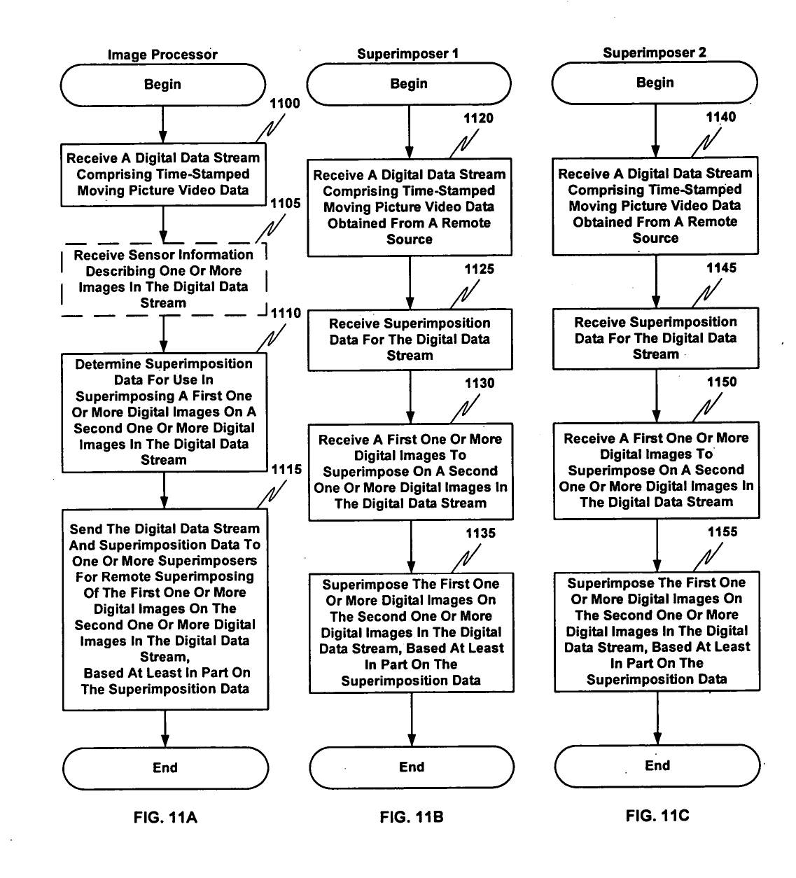

FIGS. 10-11B illustrate systems and method for multi-level distributed synchronous program superimposition in accordance with one embodiment of the present invention.

Turning now to FIG. 10, a block diagram that illustrates a system for multi-level distributed synchronous program superimposition in accordance with one embodiment of the present invention is presented. As shown in FIG. 10, one or more imaging devices such as cameras 1025 or the like are adapted to send a scene image stream 1020 comprising a digital video data stream having time-stamped moving picture video data for a scene 1005 to one or more image processors 1015. The one or more image processors 1015 comprise one or more memories and at least one processor adapted to receive the scene image stream 1020. The one or more image processors 1015 optionally receive sensor information 1010 from one or more sensors at the scene 1005.

The one or more image processors 1015 are further adapted to determine superimposition data (1075, 1070) for use in superimposing a first one or more digital images (1045, 1096) on a second one or more digital images in the digital video data stream (1035, 1065), and send the digital video data stream (1035, 1065) and superimposition data (1075, 1070) to one or more superimposers (1098, 1040) for remote superimposing of the first one or more digital images (1045, 1096) on the second one or more digital images in the digital video data stream (1035, 1065), based at least in part on the superimposition data (1075, 1070).

A first one or more superimposers 1098 are operatively coupled to the one or more image processors 1015, e.g. via a network, dedicated, or other communications means. The first one or more superimposers 1098 comprise one or more memories and at least one processor adapted to the scene image stream 1035 comprising time-stamped moving picture video data obtained from a remote source, receive superimposition data 1030 for the digital video data stream, receive a first one or more digital images 1045 to superimpose on a second one or more digital images, and superimpose the first one or more digital images 1045 on the second one or more digital images in the digital video data stream 1035, based at least in part on the superimposition data 1030. Synchronization between the scene image stream 1035, the superimposition data 1075, and the first one or more superimposable images 1045 may be based at least in part on time stamp information in the scene image stream 1035 and the superimposition data 1075.

A second one or more superimposers 1040 are operatively coupled to the first one or more superimposers 1098, the one or more image processors 1015, or both, e.g. via a network, dedicated, or other communications means. The second one or more superimposers 1040 comprise one or more memories and at least one processor adapted to receive a scene image stream (1065, 1080) comprising time-stamped moving picture video data obtained from a remote source, receive superimposition data 1070 for the digital video data stream (1065, 1080), receive a third one or more digital images 1096 to superimpose on the second one or more digital images in the digital video data stream (1065, 1080), and superimpose the third one or more digital images 1096 on the second one or more digital images in the digital video data stream (1065, 1080), based at least in part on the superimposition data 1070. Synchronization between the streams may be. based at least in part on time stamp information in the streams. The second superimposed image stream 1050 is received and displayed by a display device 1055 of user 1060.

According to one embodiment of the present invention, the one or more image processors 1015 are co-located with the one or more cameras 1025 and scene 1005. According to another embodiment of the present invention, at least part of the one or more image processors 1015 are not co-located with the one or more cameras 1025, scene 1005, or both.

According to one embodiment of the present invention, superimposition data 1075 and scene image stream 1035 comprise separate data streams having time-stamped data for communication between the one or more image processors 1015 and the first one or more superimposers 1098. The two data streams may be communicated using the same communication medium; alternatively the two data streams may be communicated using different communication mediums. The two data streams may also be communicated using the same communication protocol; alternatively the two data streams may be communicated using different communication protocols. The two data streams may also be communicated at different times.

According to another embodiment of the present invention, superimposition data 1070 and scene image stream 1065 comprise separate data streams having time-stamped data for communication between the one or more image processors 1015 and the second one or more superimposers 1040. The two data streams may be communicated using the same communication medium; alternatively the two data streams may be communicated using different communication mediums. The two data streams may also be communicated using the same communication protocol; alternatively the two data streams may be communicated using different communication protocols. The two data streams may also be communicated at different times.

According to another embodiment of the present invention, superimposition data 1030 and scene image stream 1035 comprise a single multiplexed data stream for communication between the one or more image processors 1015 and the first one or more superimposers 1098.

According to another embodiment of the present invention, superimposition data 1070 and scene image stream 1065 comprise a single multiplexed data stream for communication between the one or more image processors 1015 and the second one or more superimposers 1040.

According to one embodiment of the present invention, at least part of the data communicated between the one or more image processors 1015 and the first one or more superimposers 1098, or between the one or more image processors 1015 and the second one or more superimposers 1040, are communicated in a “user data” data field specified by an MPEG standard. Exemplary MPEG standards include, by way of example, MPEG-1, MPEG-2, and MPEG-4. According to another embodiment of the present invention, at least part of the data communicated between the one or more image processors 1015 and the first one or more superimposers 1098, or between the one or more image processors 1015 and the second one or more superimposers 1040 are communicated using one or more picture header extension codes specified by an MPEG standard. According to another embodiment of the present invention, at least part of the data communicated between the one or more image processors 1015 and the first one or more superimposers 1098, or between the one or more image processors 1015 and the second one or more superimposers 1040, are communicated using a separate data PES (Packetized Elementary Stream) specified by an MPEG standard.

According to one embodiment of the present invention, the rate at which the first one or more superimposers 1098 and the second one or more superimposers 1040 update frames within the scene image stream 1035 is based at least in part on the update rate of the original content at the image source 1000. According to another embodiment of the present invention, the rate at which the first one or more superimposers 1098 and the second one or more superimposers 1040 update frames within the scene image stream (1035, 1065) is based at least in part on the refresh rate of the display device 1055.

According to one embodiment of the present invention, the one or more superimposable images 1045 are provided by a global server (not shown in FIG. 10) having a store of one or more superimposable images. The determination of which superimposable image to use may be based in part on, by way of example, the geographic area or service area of viewers served by the first one or more superimposers 1098 and the second one or more superimposers 1040. According to another embodiment of the present invention, the first one or more superimposable images 1045 are provided by one or more regional servers (not shown in FIG. 10) having a store of one or more superimposable images, and the second one or more superimposable images 1096 are provided by one or more local servers (not shown in FIG. 10) having a store of one or more superimposable images. Each of the one or more regional servers or the one or more local servers may correspond to a particular geographic region or service area. The determination of which superimposable image to use may be based in part on, by way of example, the geographic area or service area of viewers served by the first one or more superimposers 1098 and the second one or more superimposers 1040.

According to another embodiment of the present invention, the second one or more superimposers 1040 receives the first superimposed image stream 1080 from the first one or more superimposers 1098. According to another embodiment of the present invention, the second one or more superimposers 1040 receive superimposition data 1075 from the first one or more superimposers 1098. According to another embodiment of the present invention, the second one or more superimposers 1098 receive the second one or more superimposable images 1096 from the first one or more superimposers 1098.

Turning now to FIG. 11A, a flow diagram that illustrates a method for image processing in the system for multi-level distributed synchronous program superimposition of FIG. 10, in accordance with one embodiment of the present invention is presented. FIG. 11A describes a process performed by the one or more image processors 1015 of FIG. 10. The processes illustrated in FIG. 11A may be implemented in hardware, software, firmware, or a combination thereof. At 1100, a digital video data stream comprising time-stamped moving picture video data is received. At 1105, superimposition data for use in superimposing a first one or more digital images on a second one or more digital images in the digital video data stream is determined. At 1115, the digital video data stream and superimposition data is sent to one or more superimposers for remote superimposing of the first one or more digital images on the second one or more digital images in the digital video data stream, based at least in part on the superimposition data.

Turning now to FIG. 11B, a flow diagram that illustrates a first method for superimposing one or more digital images in the system for multi-level distributed synchronous program superimposition of FIG. 10, in accordance with one embodiment of the present invention is presented. FIG. 11B describes a process performed by the first one or more superimposers 1098 of FIG. 10. The processes illustrated in FIG. 11B may be implemented in hardware, software, firmware, or a combination thereof. At 1120, a digital video data stream comprising time-stamped moving picture video data obtained from a remote source is received. At 1125, superimposition data for the digital video data stream is received. At 1130, a first one or more digital images to superimpose on a second one or more digital images in the digital video data stream are received. At 1135, the first one or more digital images are superimposed on the second one or more digital images in the digital video data stream, based at least in part on the superimposition data.

Turning now to FIG. 11C, a flow diagram that illustrates a second method for superimposing one or more digital images in the system for multi-level distributed synchronous program superimposition of FIG. 10, in accordance with one embodiment of the present invention is presented. FIG. 11C describes a process performed by the second one or more superimposers 1040 of FIG. 10. The processes illustrated in FIG. 11C may be implemented in hardware, software, firmware, or a combination thereof. At 1140, a digital video data stream comprising time-stamped moving picture video data obtained from a remote source is received. At 1145, superimposition data for the digital video data stream is received. At 1150, a first one or more digital images to superimpose on a second one or more digital images in the digital video data stream are received. At 1155, the first one or more digital images are superimposed on the second one or more digital images in the digital video data stream, based at least in part on the superimposition data.

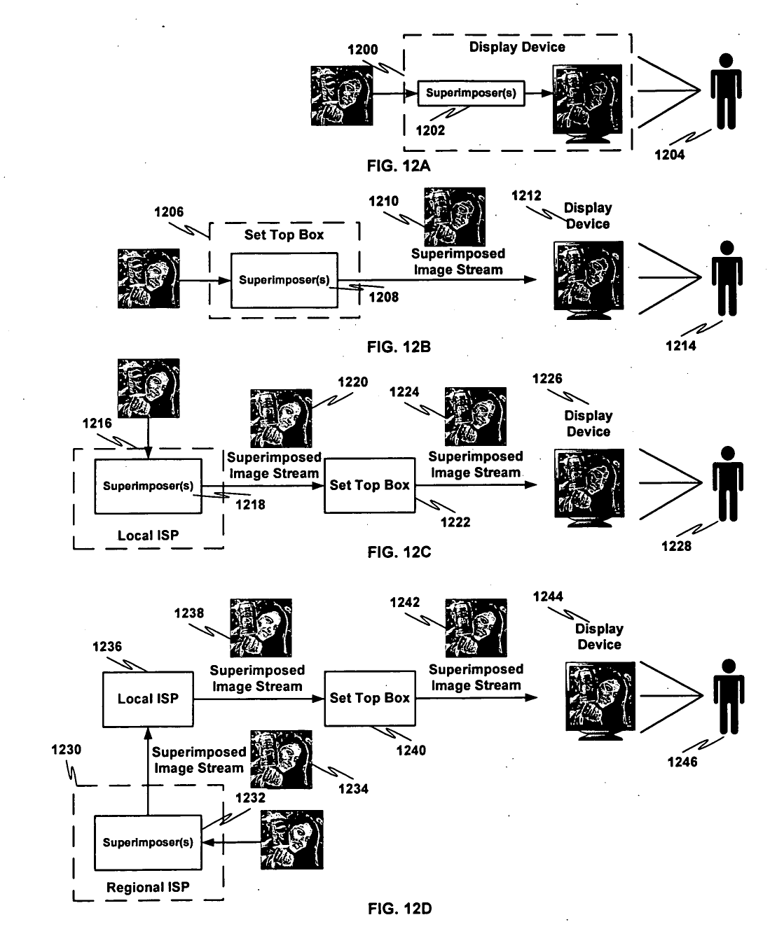

FIGS. 12A-12D illustrate systems for distributed synchronous program superimposition in accordance with embodiments of the present invention. FIG. 12A illustrates a display device 1200 comprising one or more superimposers 1202. FIG. 12B illustrates a, set top box 1206 comprising one or more superimposers 1208. FIG. 12C illustrates a local Internet Service Provider (ISP) 1216 comprising one or more superimposers 1218. FIG. 12D illustrates a regional ISP 1230 comprising one or more superimposers 1232.

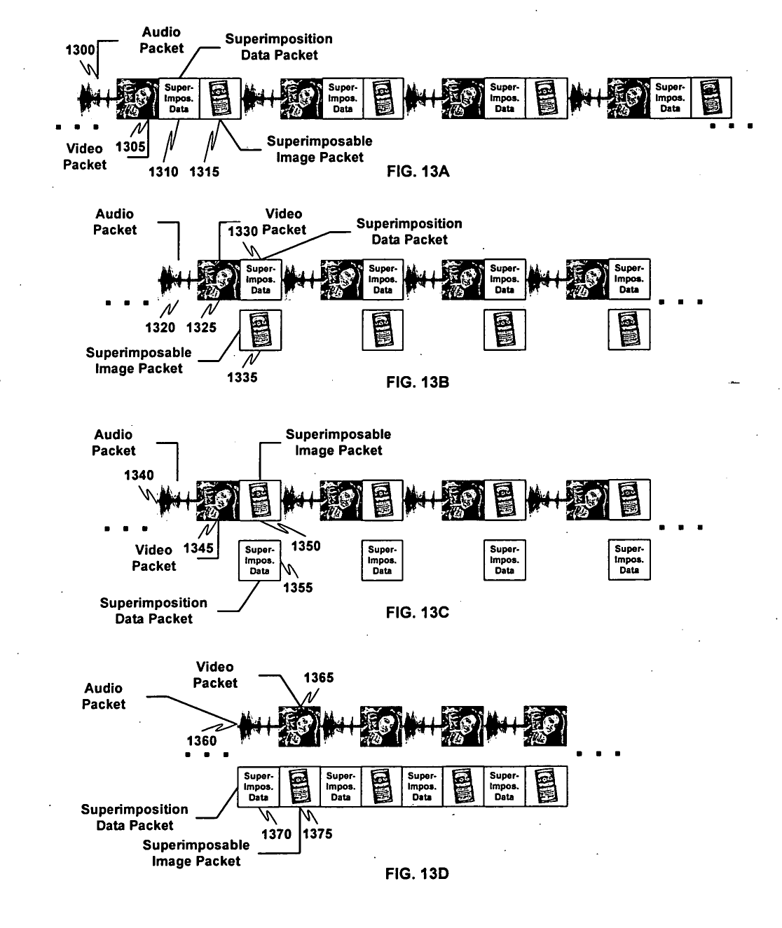

FIGS. 13A-13D illustrate various forms of data streams suitable for implementing aspects of the present invention. FIG. 13A illustrates a single data stream comprising digital audio data 1300, digital video data, 1305, superimposition data 1310, and superimposable image data 1315. FIG. 13B illustrates a first data stream comprising digital audio data 1320, digital video data, 1325, and superimposition data 1330, and a second data stream comprising superimposable image data 1335. FIG. 13C illustrates a first data stream comprising digital audio data 1340, digital video data, 1345, and superimposable image data 1350, and a second data stream comprising superimposition data 1355. FIG. 13D illustrates a first data stream comprising digital audio data 1360 and digital video data 1365, and a second data stream comprising superimposition data 1370 and superimposable image data 1375. FIGS. 13A-13D are for the purpose of illustration and are not intended to be limiting in any way. Although audio data (1300, 1320, 1340, 1360) is shown in FIGS. 13A-13D, embodiments of the present invention do not require audio data.

A program or programs may be provided having instructions adapted to cause a processing unit or a network of data processing units to realize elements of the above embodiments and to carry out the method of at least one of the above operations. Furthermore, a computer readable medium may be provided, in which a program is embodied, where the program is to make a computer execute the method of the above operation.

Also, a computer-readable medium may be provided having a program embodied thereon, where the program is to make a card device to execute functions or operations of the features and elements of the above described examples. A computer-readable medium can be a magnetic or optical or other tangible medium on which a program is recorded, but can also be a signal, e.g. analog or digital, electronic, magnetic or optical, in which the program is embodied for transmission. Furthermore, a data structure or a data stream may be provided comprising instructions to cause data processing means to carry out the above operations. The data stream or the data structure may constitute the computer-readable medium. Additionally, a computer program product may be provided comprising the computer-readable medium.

Although embodiments of the present invention have been illustrated with respect to the superimposition of digital video data, the invention may also be applied to digital audio or digital audio/video data. By way of example, a first one or more digital audio track could be superimposed on a second one or more digital audio track in a distributed and synchronous manner.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for distributed synchronous program superimposition, the method comprising:
receiving a digital video data stream comprising time-stamped moving picture video data;
determining superimposition data for use in superimposing a first one or more digital images on a second one or more digital images in said digital video data stream; and
sending said digital video data stream and said superimposition data to one or more superimposers for remote superimposing of said first one or more digital images on said second one or more digital images in said digital video data stream, said superimposing based at least in part on said superimposition data.

2. The method of claim 1, further comprising receiving sensor information describing said second one or more digital images.

3. The method of claim 2 wherein said sensor information indicates one or more coordinates of said second one or more digital images.

4. The method of claim 1 wherein said superimposition data comprises information regarding said second one or more digital images.

5. The method of claim 4 wherein said superimposition data comprises information regarding an orientation of said second one or more digital images.

6. The method of claim 4 wherein said superimposition data comprises information regarding lighting characteristics of said second one or more digital images.

7. The method of claim 4 wherein said superimposition data comprises information regarding shading characteristics of said second one or more digital images.

8. The method of claim 4 wherein said superimposition data comprises information regarding opacity characteristics of said second one or more digital images.

9. The method of claim 4 wherein said superimposition data comprises information regarding aspect ratio characteristics of said second one or more digital images.

10. The method of claim 1 wherein said sending further comprises sending said digital video data stream and said superimposition data in a single multiplexed data stream.

11. The method of claim 1 wherein said sending further comprises sending said digital video data stream and said superimposition data in separate data streams.

12. The method of claim 1 wherein said sending further comprises sending at least part of said digital video data stream or said superimposition data using a user data field as specified by an MPEG (Motion Pictures Experts Group) standard.

13. The method of claim 1 wherein said sending further comprises sending at least part of said digital video data stream or said superimposition data using one or more picture header extension codes specified by an MPEG standard.

14. A method for distributed synchronous program superimposition, the method comprising:
receiving from a remote source a digital video data stream comprising time-stamped moving picture video data;
receiving superimposition data for said digital video data stream;
receiving a first one or more digital images to superimpose on a second one or more digital images in said digital video data stream; and
superimposing said first one or more digital images on said second one or more digital images in said digital video data stream to create a superimposed image stream, said superimposing based at least in part on said superimposition data.

15. The method of claim 14 wherein said superimposition data comprises information regarding said second one or more digital images.

16. The method of claim 15 wherein said superimposition data comprises information regarding an orientation of said second one or more digital images.

17. The method of claim 15 wherein said superimposition data comprises information regarding lighting characteristics of said second one or more digital images.

18. The method of claim 15 wherein said superimposition data comprises information regarding shading characteristics of said second one or more digital images.

19. The method of claim 15 wherein said superimposition data comprises information regarding opacity characteristics of said second one or more digital images.

20. The method of claim 15 wherein said superimposition data comprises information regarding aspect ratio characteristics of said second one or more digital images.

21. The method of claim 14, further comprising receiving said digital video data stream and said superimposition data in a single multiplexed data stream.

22. The method of claim 14, further comprising receiving said digital video data stream and said superimposition data in separate data streams.

23. The method of claim 14, further comprising receiving at least part of said digital video data stream or said superimposition data using a user data field as specified by an MPEG (Motion Pictures Experts Group) standard.

24. The method of claim 14, further comprising receiving at least part of said digital video data stream or said superimposition data using one or more picture header extension codes specified by an MPEG standard.

25. The method of claim 14, further comprising displaying said superimposed image stream on a display device.

26. A program storage device readable by a machine, embodying a program of instructions executable by the machine to perform a method for distributed synchronous program superimposition, the method comprising:
receiving a digital video data stream comprising time-stamped moving picture video data;
determining superimposition data for use in superimposing a first one or more digital images on a second one or more digital images in said digital video data stream; and
sending said digital video data stream and said superimposition data to one or more superimposers for remote superimposing of said first one or more digital images on said second one or more digital images in said digital video data stream, said superimposing based at least in part on said superimposition data.

27. A program storage device readable by a machine, embodying a program of instructions executable by the machine to perform a method for distributed synchronous program superimposition, the method comprising:
receiving from a remote source a digital video data stream comprising time-stamped moving picture video data;
receiving superimposition data for said digital video data stream;
receiving a first one or more digital images to superimpose on a second one or more digital images in said digital video data stream; and
superimposing said first one or more digital images on said second one or more digital images in said digital video data stream to create a superimposed image stream, said superimposing based at least in part on said superimposition data.

28. An apparatus for distributed synchronous program superimposition, the apparatus comprising:
means for receiving a digital video data stream comprising time-stamped moving picture video data;
means for determining superimposition data for use in superimposing a first one or more digital images on a second one or more digital images in said digital video data stream; and
means for sending said digital video data stream and said superimposition data to one or more superimposers for remote superimposing of said first one or more digital images on said second one or more digital images in said digital video data stream, said superimposing based at least in part on said superimposition data.

29. An apparatus for distributed synchronous program superimposition, the apparatus comprising:
means for receiving from a remote source a digital video data stream comprising time-stamped moving picture video data;
means for receiving superimposition data for said digital video data stream;
means for receiving a first one or more digital images to superimpose on a second one or more digital images in said digital video data stream; and
means for superimposing said first one or more digital images on said second one or more digital images in said digital video data stream to create a superimposed image stream, said superimposing based at least in part on said superimposition data.

30. An apparatus for distributed synchronous program superimposition, the apparatus comprising:
a memory; and
a processor adapted to:
receive a digital video data stream comprising time-stamped moving picture video data;
determine superimposition data for use in superimposing a first one or more digital images on a second one or more digital images in said digital video data stream; and
send said digital video data stream and said superimposition data to one or more superimposers for remote superimposing of said first one or more digital images on said second one or more digital images in said digital video data stream, said superimposing based at least in part on said superimposition data.

31. The apparatus of claim 30 wherein said processor is further adapted to receive sensor information describing said second one or more digital images.

32. The apparatus of claim 31 wherein said sensor information indicates one or more coordinates of said second one or more digital images.

33. The apparatus of claim 30 wherein said superimposition data comprises information regarding said second one or more digital images.

34. The apparatus of claim 33 wherein said superimposition data comprises information regarding an orientation of said second one or more digital images.

35. The apparatus of claim 33 wherein said superimposition data comprises information regarding lighting characteristics of said second one or more digital images.

36. The apparatus of claim 33 wherein said superimposition data comprises information regarding shading characteristics of said second one or more digital images.

37. The apparatus of claim 33 wherein said superimposition data comprises information regarding opacity characteristics of said second one or more digital images.

38. The apparatus of claim 33 wherein said superimposition data comprises information regarding aspect ratio characteristics of said second one or more digital images.

39. The apparatus of claim 30 wherein said sending further comprises sending said digital video data stream and said superimposition data in a single multiplexed data stream.

40. The apparatus of claim 30 wherein said sending further comprises sending said digital video data stream and said superimposition data in separate data streams.

41. The apparatus of claim 30 wherein said processor is further configured to send at least part of said digital video data stream or said superimposition data using a user data field as specified by an MPEG (Motion Pictures Experts Group) standard.

42. The apparatus of claim 30 wherein said processor is further configured to send at least part of said digital video data stream or said superimposition data using one or more picture header extension codes specified by an MPEG standard.

43. An apparatus for distributed synchronous program superimposition, the apparatus comprising:
a memory; and
a processor adapted to:
receive from a remote source a digital video data stream comprising time-stamped moving picture video data;
receive superimposition data for said digital video data stream;
receive a first one or more digital images to superimpose on a second one or more digital images in said digital video data stream; and
superimpose said first one or more digital images on said second one or more digital images in said digital video data stream to create a superimposed image stream, said superimposing based at least in part on said superimposition data.

44. The apparatus of claim 43 wherein said superimposition data comprises information regarding said second one or more digital images.

45. The apparatus of claim 44 wherein said superimposition data comprises information regarding an orientation of said second one or more digital images.

46. The apparatus of claim 44 wherein said superimposition data comprises information regarding lighting characteristics of said second one or more digital images.

47. The apparatus of claim 44 wherein said superimposition data comprises information regarding shading characteristics of said second one or more digital images.

48. The apparatus of claim 44 wherein said superimposition data comprises information regarding opacity characteristics of said second one or more digital images.

49. The apparatus of claim 44 wherein said superimposition data comprises information regarding aspect ratio characteristics of said second one or more digital images.

50. The apparatus of claim 43 wherein said processor is further adapted to receive said digital video data stream and said superimposition data in a single multiplexed data stream.

51. The apparatus of claim 43 wherein said processor is further adapted to receive said digital video data stream and said superimposition data in separate data streams.

52. The apparatus of claim 43 wherein said processor is further adapted to receive at least part of said digital video data stream or said superimposition data using a user data field as specified by an MPEG (Motion Pictures Experts Group) standard.

53. The apparatus of claim 43 wherein said processor is further adapted to receive at least part of said digital video data stream or said superimposition data using one or more picture header extension codes specified by an MPEG standard.

54. The apparatus of claim 43 wherein said apparatus is comprised by a display device.

55. The apparatus of claim 43 wherein said apparatus is comprised by a set top box.

56. The apparatus of claim 43 wherein said apparatus is comprised by a local ISP (Internet Service Provider).

57. The apparatus of claim 43 wherein said apparatus is comprised by a regional ISP (Internet Service Provider).

58. The apparatus of claim 43 wherein said processor is further adapted to display said superimposed image stream on a display device.
